(19) United States
(12) Patent Application Publication
(10) Pub. No.: US 2024/0424448 A1
(43) Pub. Date: Dec. 26, 2024

(54) Spiral Element Construction Yielding Enhanced Capacity

(71) Applicant: Aqua Membranes, Inc., Albuquerque, NM (US)

(72) Inventors: Rodney Herrington, Albuquerque, NM (US); Kevin Roderick, Albuquerque, NM (US); Christopher Kurth, Eden PRairie, MN (US)

(21) Appl. No.: 18/751,107

(22) Filed: Jun. 21, 2024

Related U.S. Application Data
(63) Continuation of application No. PCT/US22/82392, filed on Dec. 27, 2022.
(60) Provisional application No. 63/294,378, filed on Dec. 28, 2021.
(60) Provisional application No. 63/294,377, filed on Dec. 28, 2021.

(51) Int. Cl. B01D 63/10; B01D 69/02

(52) U.S. Cl. CPC B01D 63/101; B01D 69/02; B01D 2325/04; B01D 2325/24

(57) ABSTRACT

Printed spacer membrane elements offer the unique advantage of applying any pattern on the membrane surface to act as the feed spacer material. This is in contrast to conventional feed spacer mesh material that is uniform in thickness and density throughout the mesh. More open feed spaces can be utilized allowing closer spacing between membrane sheets in the feed space which allows more membrane sheet to be wrapped around the membrane element—resulting in more permeate flow—while simultaneously reducing the pressure loss from the feed to reject end of the element. Unique design features of printed spacers dramatically improve performance of membrane elements in contrast to conventional feed spacer mesh elements in the prior art.

### TECHNICAL FIELD

The subject invention relates to a membrane system utilized for the separation of fluid components, specifically spiral-wound membrane elements.

### BACKGROUND ART

In cross-flow filtration, a feed fluid flows through a spiral wound filter and is released at the other end, while some portion of the fluid is removed by filtration through a membrane surface which is parallel to the direction of fluid flow. Various forms of cross-flow filtration exist including plate-and-frame, cassette, hollow-fiber, or spiral wound systems. Plate-and-frame, cassette, and spiral-wound filtration modules often rely on stacked membrane layers which provide spacing between adjacent layers of filtration membrane and the present invention is applicable to such systems.

Spiral-wound membrane filtration elements are well known in the art which consist of laminated structure comprised of a membrane sheet sealed to or around a porous permeate carrier which creates a path for removal, longitudinally to the axis of the center tube, of the fluid passing through the membrane to a central tube, while this laminated structure is wrapped spirally around the central tube and spaced from itself with a porous feed spacer to allow axial flow of the fluid through the element from the feed end of the element to the reject end. Traditionally, a feed spacer mesh is used to allow flow of the feed water, some portion of which will pass through the membrane, into the spiral wound element and allow reject water to exit the element in a direction parallel to the center tube and axial to the element construction.

Improvements to the design of spiral wound elements have been disclosed in U.S. Pat. No. 6,632,357 to Barger et al, U.S. Pat. No. 7,311,831 to Bradford et al, and patents in Australia (2014223490), Japan (6499089), China (CN105163834B), Israel (240883), and South Korea (10-2196776) entitled “Improved Spiral Wound Element Construction” to Herrington et al which replaces the feed spacer with islands or protrusions either printed, deposited or embossed directly onto the inside or outside surface of the membrane, or on the permeate carrier. U.S. Pat. No. 11,090,612 entitled “Graded spacers for filtration wound elements” to Roderick, et al, describe the use of height graded spacer features which are used to alter feed flow characteristics in a spiral wound element. US patent application PCT/US17/62424 entitled “Interference Patterns for Spiral Wound Elements” to Roderick, et al, describes patterns in spiral wound elements that keep membrane feed spaces open but also provide support for the membrane envelope glue areas during rolling. US patent application PCT/US18/55671 entitled “Bridge Support and Reduced Feed Spacers for Spiral-Wound Elements” to Roderick et al describes support features that are applied to the distal end (farthest end from the center tube) of the membrane envelop to provide support during gluing and rolling of the spiral wound element. US provisional application number 63,051,738 entitled “Variable Velocity Patterns in Cross Flow Filtration” to Herrington et al describes support patterns that vary in size from the feed to the reject end of the membrane feed space in the feed flow path parallel to the center tube in order to control the velocity of the feed solution as the concentration of the feed solution increases from the feed to the reject end of the spiral wound element. U.S. Pat. No. 11,083,997 to Roderick, et al entitled “Non-Nesting, Non-Deforming Patterns in Spiral Wound Elements” describe denser patterns in the feed and reject ends of the membrane feed space, and a more open pattern in the middle, in order to avoid nesting of the printed patterns at the adhesive lines during element fabrication.

### BRIEF SUMMARY OF THE INVENTION

The present invention describes a novel methods of fabricating spiral wound membrane elements that provide increased permeate flow concurrent with reduced energy consumption versus that available in the existing state-of-the-art that use conventional mesh feed spacers.

Embodiments of the present invention provide a spiral wound element comprising one or more membrane sheets, each membrane sheet being folded on itself at a fold line providing first and second membrane halves facing each other, wherein each folded membrane sheet is spirally wound around the center tube with the fold line proximal the center tube, and the first membrane half forming an inner wind relative to the second membrane half, each membrane sheet having a plurality of spacing features disposed on a surface of at least one of the first and second halves, where the distance from the fold line to the first spacing feature is greater than or equal to the diameter of the center tube divided by the number of membrane sheets with fold lines proximal the center tube.

In some embodiments, the spacing features are disposed on the first membrane half and not on the second membrane half. In some embodiments, the spacing features are disposed on the second membrane half and not on the first membrane half. Some embodiments further comprise a permeable permeate carrier between each pair of adjacent folded membrane sheets where the permeate carrier is mounted adjacent to the inactive side of the folded membrane sheets. There can be one or more folded membrane sheets in a spiral wound element.

In some embodiments, the areal packing density of membrane in the element is greater than 33 in2/in3. In some embodiments, the areal packing density of membrane in the element is greater than 35 in2/in3. In some embodiments, the areal packing density of membrane in the element is greater than 39 in2/in3. In some embodiments, the areal packing density of membrane in the element is greater than 41 in2/in3. In some embodiments, the areal packing density of membrane in the element is greater than 43 in2/in3.

In some embodiments, the spacing features have a height extending above the corresponding membrane, where the height of spacing features near the fold line is less than the height of spacing features distant from the fold line. In some embodiments, the spacing features distant from the fold line by more than the radius of the center tube have a height that is constant, and spacing features that are closer to the fold line than the diameter of the center tube have a height that increases with distance from the fold line. In some embodiments, the spacing features distant from the fold line by more than the diameter of the center tube have a height that is constant, and spacing features that are closer to the fold line than the diameter of the center tube have a height that increases with distance from the fold line. In some embodiments, the spacing features distant from the fold line by more than the circumference of the center tube have a height that is constant, and spacing features that are closer to the fold line than the diameter of the center tube have a height that increases with distance from the fold line.

In some embodiments, the spacing features occupy less than 7% of the volume between the membrane halves. In some embodiments, the spacing features occupy less than 5% of the volume between the membrane halves. In some embodiments, the spacing features occupy less than 2% of the volume between the membrane halves. In some embodiments, the spacing features occupy less than 7% of the area of the membrane on which they are deposited. In some embodiments, the spacing features occupy less than 5% of the area of the membrane on which they are deposited. In some embodiments, the spacing features occupy less than 2% of the area of the membrane on which they are deposited.

Embodiments of the present invention provide an assembly, comprising (a) a plurality of folded membranes, each folded membrane comprising a membrane sheet having an active surface and an inactive surface opposite the active surface, the membrane sheet folded in half along a fold line with the active surfaces facing each other, wherein the membrane sheet has disposed thereon a plurality of spacing features in a region less than 0.1 inch from the fold line having no spacing features; (b) a plurality of permeable permeate carrier sheets; (c) a center tube; (d) wherein the permeate carrier sheets are spirally wound about the center tube and welded together with a folded membrane in between each pair of permeate carrier sheets.

In some embodiments, the permeate carrier sheets are welded together with a leading edge of each successive permeate carrier sheet separated from the leading edge of the preceding permeate carrier sheet by no more than the circumference of the center tube divided by the number of permeate carrier sheets. In some embodiments, a second permeate carrier sheet is welded to a first permeate carrier sheet at a distance at least the circumference of the center tube and a third permeate carrier sheet is welded to the second permeate carrier sheets at a distance by no more than the circumference of the center tube divided by the number of permeate carrier sheets.

Embodiments of the present invention provide a spiral wound fluid treatment element, comprising: (a) a collection tube; (b) one or more membrane sheets, each having a first surface suitable for contacting fluid to be treated and a second surface, opposite the first surface, the membrane sheet spirally wound around the collection tube; (c) a plurality of spacing features disposed on a first half of the first surface of each membrane sheets, wherein each spacing feature has a cross-section perpendicular to the axis of the collection tube that has a first end and a second end and extends from the first end to the second end, wherein the first end is wider than the second end.

In some embodiments, the first ends of the spacing elements are in contact with the first half of the corresponding membrane sheet, and wherein the first surface of the first half of the membrane sheet faces away from the collection tube. In some embodiments, the first ends of the spacing elements are in contact with the first half of the corresponding membrane sheet, and wherein the first surface of the first half of the membrane sheet faces toward the collection tube.

In some embodiments, the ratio of the second end width to the first end width is less than 0.98. In some embodiments, the ratio of the second end width to the first end width is less than 0.95. In some embodiments, the ratio of the second end width to the first end width is less than 0.85. In some embodiments, the spacing elements comprise one or more of thermoplastics, reactive polymers, waxes, or resins.

Embodiments of the present invention provide a spiral wound fluid treatment element, comprising: (a) a collection tube; (b) a plurality of membrane sheets, each having an active surface and an inactive surface opposite the active surface, wherein each membrane sheet is folded along a fold line such that the active surfaces face each other, and wherein each membrane sheet is disposed with the fold line proximal the collection tube; (c) wherein each membrane sheet has disposed on the active surface thereof a plurality of spacing features, wherein each spacing feature has a cross-section perpendicular to the axis of the collection tube that has a first end and a second end and extends from the first end to the second end, wherein the first end is wider than the second end.

Embodiments of the present invention provide a spiral wound element comprising printed features disposed on a membrane wherein a width R of a feature at the membrane surface is different than the width S of the feature at the top of the feature, with S<R and the membrane sheets oriented such that for a given feature, the location of the width R is further from the center tube than location of the width S.

In some embodiments, the spacing features extend from the corresponding membrane a distance of 0.003″ to 0.050″.

### BRIEF DESCRIPTION OF THE DRAWINGS

FIG. 1 is an exploded view of a spiral wound membrane element.

FIG. 2 is an exploded view of a partially assembled spiral wound membrane element.

FIG. 3 is an end view of a spiral wound element prior to rolling with multiple membrane sheets around the center tube.

FIG. 4, comprising FIG. 4A and FIG. 4B, is two views showing a unit cross-section area of a mesh element of the current art (FIG. 4A) and a printed spacer element (FIG. 4B) both of the same height feed channel.

FIG. 5, comprising FIG. 5A and FIG. 5B, is two views showing the effective flow cross section of a mesh element of the current art (FIG. 5A) and a thin printed spacer element (FIG. 5B) with a shorter height feed channel.

FIG. 6 is a view of a printed membrane sheet with a dense glue support line on the inlet and outlet regions of the membrane sheet, and a less dense region in the center.

FIG. 7, comprising FIG. 7A and FIG. 7B, provides two views of a center tube with less dense pattern of holes and in the center tube (FIG. 7A) and a dense pattern of holes in the center tube (FIG. 7B).

FIG. 8 is an end view of two membrane leaves being rolled around a center tube with trapezoidal feed spacer elements.

FIG. 9 is an end view of two membrane leaves being rolled around a center tube with trapezoidal feed spacer elements.

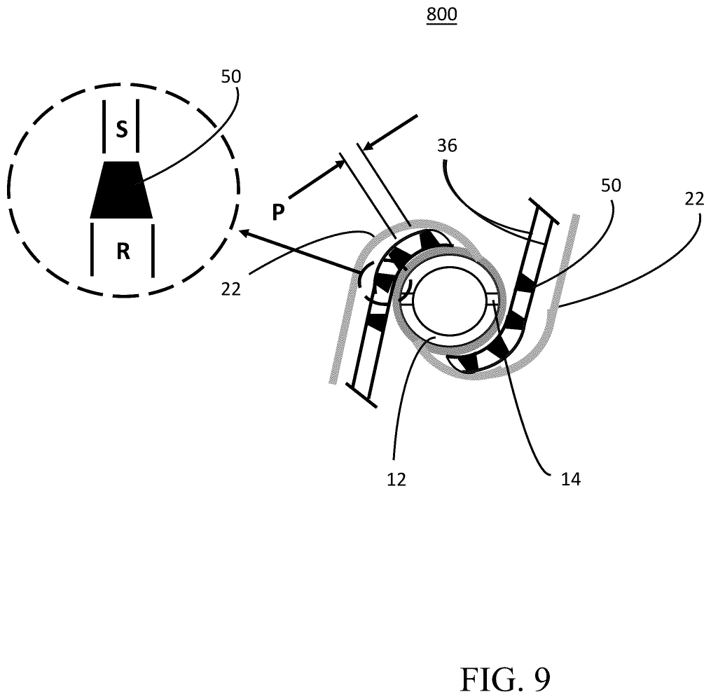

### MODES FOR CARRYING OUT THE INVENTION AND INDUSTRIAL APPLICABILITY

The feed spacer in a spiral wound filtration element is required to maintain a channel for fluid to flow from the feed to reject end of the feed channel, but the spacer design also impacts the differential pressure loss from the feed to reject end of the element, local flow velocities, turbulence, stagnation zones and other fluid flow conditions. Extruded mesh feed spacers have been used traditionally in membrane manufacture, but by the nature of their design many of their hydrodynamic characteristics are dependent on the thickness of the spacer. Conventional mesh spacers also provide uniform support characteristics in the feed space all the way from the distal end from the center tube to the proximal end of the membrane sheet near the center tube. Printed feed spacers allow for unique design characteristics unobtainable with conventional extruded or woven mesh spacers. Printed spacers thickness and geometry can be changed independently to yield a wide range of configurations which can be tailored to specific applications or specific challenges found in spiral wound membrane element application. One of the key features of printed spacer technology is the open architecture of the feed channel. Conventional mesh spacers consist of two layers of stringers criss-crossed over each other and welded or bonded at the intersection of the two stringers to provide structure to the mesh. By its very nature, all of the fluid must pass over one of the stringers, around the stringer, and back over the opposing stringer. A mesh stringer running all the way across the feed space, even if it is not normal to the flow path, creates an inherent restriction in the height of the flow channel. Printed feed spacers have no inherent restriction. The channel height on printed spacers can be half the height of the conventional mesh spacer, providing the same mass flow characteristics and same pressure drop feed to reject as the mesh spacer. Conventional mesh spacers in 40-inch long elements are typically in the range of 26 to 32 mils (0.026 to 0.032 inches) but can be higher or lower for unique applications. Printed spacer technology allows spacer heights much lower, typically 15 to 20 mils (0.015 to 0.020 inches) and provide the same mass flow characteristics with equivalent pressure drop feed to reject as mesh spacers in 40″ long elements. In 12″ long or shorter elements, the spacing height can be as low as 0.003″, but typically 0.006″ to 0.008″ tall. One of the primary characteristics of mesh spacers commonly expressed as an advantage is that the mesh creates substantial mixing in the flow stream that helps reduce concentration polarization. Concentration polarization is the tendency of ions in the fluid stream to stack up at the membrane surface as fluid molecules pass through the membrane and increase the concentration of the total dissolved solids (TDS) at the membrane surface, and thereby increases the osmotic pressure required to drive the fluid molecules through the membrane surface. Other disadvantages of concentration polarization are an increase in the TDS that transfers through the membrane surface reducing the quality of the product water, otherwise known as a loss of rejection. Concentration polarization can have more obvious effects in high TDS water such as seawater where increases in osmotic pressure are more dramatic due to higher TDS at the reject end of the element. For fresh water, high rejection is typically not as important. However, in some industrial applications such as semiconductor processing, high rejection is desirable even in low TDS applications. For water containing sparingly soluble species, the combined effects of system recovery and polarization can also lead to precipitation at the reject end of the element, or at the last element in a multi-element pressure vessel. These characteristics may restrict the recovery of reverse osmosis systems. In any event, printed spacer technology can have a wide variety of printed features to create mixing that is needed for concentration polarization to be minimized.

Cross-flow filtration, by its nature, relies on some portion of the feed fluid to pass through the filter and become part of the filtrate, thus creating a situation where the quantity of the feed fluid is constantly being reduced as it passes through the filter. The higher the portion of filtrate produced, the lower the portion of feed/concentrate fluid that remains flowing through the filter. As a fluid flows through the element, a portion of the fluid passes through the membrane. Modeled simply, a constant flux through the membrane produces a gradually decreasing flow of the feed solution as it flows from the feed to the reject end of the feed space in the element. In reality, the amount of fluid passing through any location along the feed flow path depends on local flow conditions and local concentrations of solutes or suspended materials, as well as the local pressure which also depends on any back-pressure in the feed space as well as from the permeate side of the element locally.

An important advantage of printed spacer technology is that more open feed spacer channels can be created. The present invention provides a means to maximize permeate flow, increase recovery, or decrease differential pressure losses from the feed to reject end of the element, reduce scale formation potential, simplify cleaning protocols, or combinations of all of these benefits.

The feed shaping features employed may be of any of a number of shapes, including round dots, ovals, bars with rounded ends, lenticular forms, stretched polygons, arcs, lines or other geometric shapes. Due to the shape of the features and the fact that the fluid must traverse around the outside of the features, the fluid flow velocity will change locally in the areas between the feed spacing features from the feed to reject end of the membrane element.

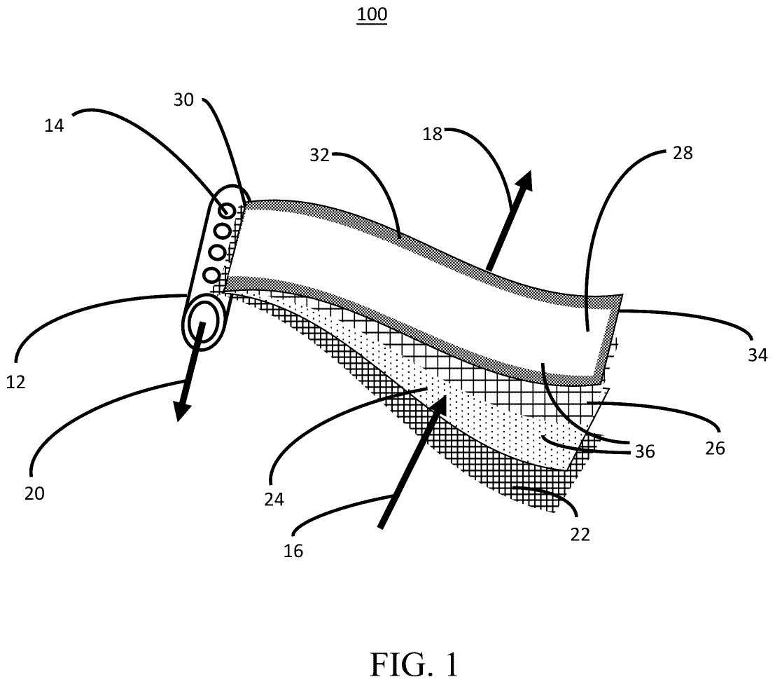

FIG. 1 is a schematic illustration of a conventional spiral wound membrane element prior to rolling, showing important elements of a conventional spiral wound membrane element 100. Permeate collection tube 12 has holes 14 in collection tube 12 where permeate fluid is collected from permeate carrier 22. In fabrication, membrane sheet 36 is a single continuous sheet that is folded at center line 30, comprised of a non-active porous support layer on one face 28, for example polyester, polysulfone, or a combination, and active polymer membrane surface 24 bonded or cast on to the support layer. In the assembled element, active polymer membrane surface 24 is adjacent to feed spacer mesh 26, and non-active support layer 28 is adjacent to permeate carrier 22 when rolled around permeate collection tube 12. In the preferred embodiment, feed spacer mesh 26 is replaced with printed features on active polymer membrane surface 24 or alternatively on non-active support layer 28 to create embossed features on active polymer membrane surface 28. Feed solution 16 enters between active polymer membrane surfaces 24 and flows through the open spaces in feed spacer mesh 26. As feed solution 16 flows through feed spacer mesh 26, particles, ions, or chemical species, which are excluded by the membrane are rejected at active polymer membrane surfaces 24, and molecules of permeate fluid, for instance water molecules, pass through active polymer membrane surfaces 24 and enter porous permeate carrier 22. As feed solution 16 passes along active polymer membrane surface 24, the concentration of materials excluded by the membrane increases due to the loss of permeate fluid in bulk feed solution 16, and this concentrated fluid exits the reject end of active polymer membrane sheet 24 as reject solution 18. Permeate fluid in permeate carrier 22 flows from distal end 34 of permeate carrier 22 in the direction of center tube 12 where the permeate fluid enters center tube 12 through center tube entrance holes 14 and exits center tube 12 as permeate solution 20. To avoid contamination of the permeate fluid with feed solution 16, non-active polymer membrane layers 28 are sealed with adhesive along adhesive line 32 through permeate carrier 22 thereby creating a sealed membrane envelope where the only exit path for permeate solution 20 is through center tube 12. Typically, the width of the adhesive line 32 is 1-3″ after the adhesive has been compressed during the rolling process.

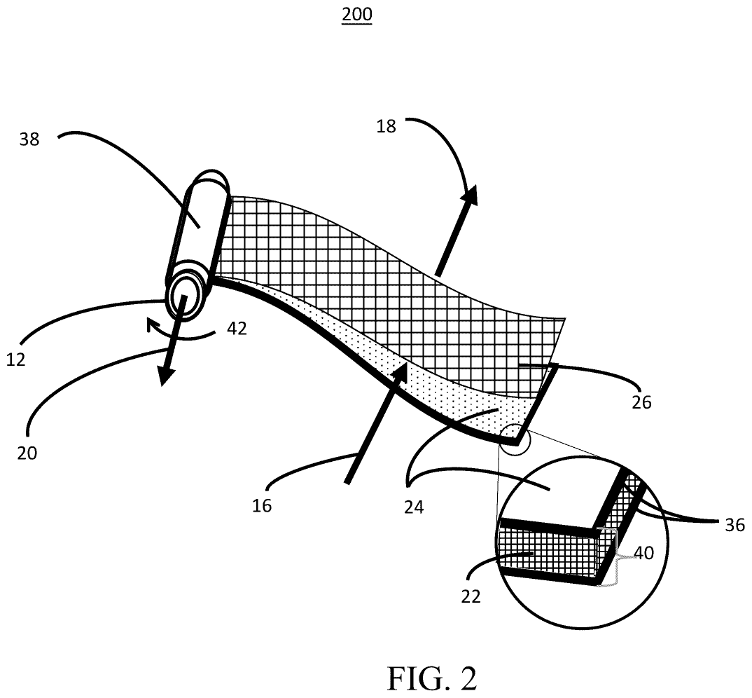

In the existing art, a partially assembled spiral wound membrane element 200 is shown in FIG. 2. A membrane envelope 40 comprises, as described in connection with FIG. 1, a membrane sheet 36 folded at one end with a permeate carrier 22 disposed therebetween the membrane sheet and sealed along the edges with a suitable adhesive line 32 (FIG. 1). In the conventional design of membrane element once rolled, a feed spacer mesh 26 is placed adjacent to envelope 40 to allow the flow of feed fluid 16 to flow between layers membrane envelope 40 and expose all of the active polymer surfaces 24 of the membrane sheet to feed fluid. Permeate, or product fluid is collected in permeate carrier 22 inside membrane envelope 40 and proceeds spirally down to center tube 12 where the product, or permeate fluid 20 is collected while the reject stream 18 exits the element. A single spiral wound element may comprise a single membrane envelope and feed spacer layer, or may comprise multiple membrane envelopes and feed spacer layers stacked and rolled together to form the element. For multiple membrane sheet elements, the permeate carrier assembly (Trico pack) consists of multiple permeate carrier sheets that are ultrasonically (or otherwise) welded together at an offset distance which is typically the distance of the center tube circumference divided by the number of leaves in the element. The first permeate carrier sheet is typically longer so that it can wrap around the center tube once or twice in order to create volume for the permeate from all of the leaves to enter the holes in the center tube without causing undue back pressure in the individual permeate leaves.

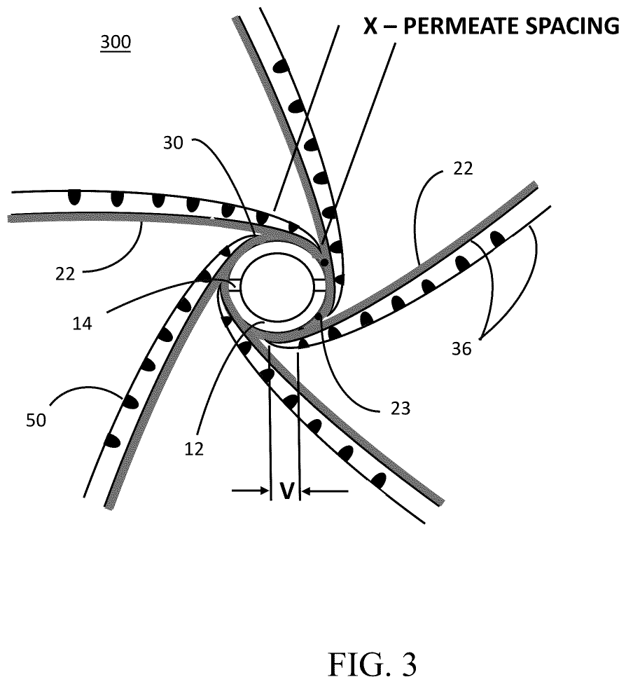

FIG. 3 depicts an important advantage of printed spacers 50 applied to the active polymer surface 24 of membrane sheet 36. Printed spacers 50 can be printed at a height of 50 percent or less of the height of conventional mesh 26 (FIG. 2). Because the thickness of membrane envelope 40 (FIG. 2) using printed spacers 50 is significantly less thickness than conventional mesh 26, many more layers of membrane envelope 40 (FIG. 2) can be wrapped around center tube 12 for the equivalent outside diameter of membrane element 200 constructed of conventional mesh 26. In practice, each of membrane envelopes 40 should begin at fold line 30 (FIG. 1) where permeate carrier 22 has been attached to center tube 12 at attachment points 23. The thickness of membrane envelope 40 including the thickness of the feed spacer, determines the total thickness per layer around center tube 12. This total thickness, in turn, determines the minimum interval X that permeate carrier 22 can be attached to center tube 12 assuming all membrane leaves start at the center tube, and are not layered on top of other leaves as they wrap around the center tube on the first layer. In an element that is 40 inches (1016 mm) long and 8 inches (203.2 mm) in diameter, center tube 12 typically has an outside diameter of 1.5 inches (39.1 mm), but can be smaller or larger. And, of course, the larger the diameter of center tube 12, the less membrane can be wrapped around center tube 12 before the outside diameter exceeds 8 inches (203.2 mm). The circumference of center tube 12 is given by TID, where D is the outside diameter of center tube 12. In the case of a 1.5-inch (39.2 mm) center tube, the circumference is 4.71 inches (119.6 mm). In practice with a thin mesh feed spacer, about 25 membrane envelopes 40 can be wrapped around center tube 12. Feed spacer mesh 26 using conventional fabrication techniques typically has thicknesses as low at 0.028 inches (0.71 mm) and are limited to this minimum thickness due to losses in feed pressure from feed to reject in the membrane element. This means that the spacing interval X has a distance of 4.71 inches divided by 25 leaves, or 0.188 inches (4.79 mm). With printed spacers 50 that are a height of 0.017 inches (0.43 mm), as many as 35 membrane sheets can be used at equivalent leaf length of conventional mesh spacer elements before the outside diameter of 8 inches (203.2 mm) is achieved. This results in 40% more membrane surface area (40% more permeate flow) but an equivalent pressure loss from feed to reject as a mesh element. Using 35 leaves on a 1.5-inch (39.2 mm) center tube, the spacing distance X can be as little as 0.135 inches (3.43 mm). The illustration and description herein assumes the permeate carriers are directly attached to the center tube. In some embodiments, a layer of permeate carrier material is wrapped around the center tube, either as a separate element or as an extension of one of the permeate carriers. Such a wrap is considered part of the center tube for the purposes of this discussion.

For a 4″ (101.6 mm) element, the center tube outside diameter is typically 0.84 inches (21.34 mm). 4-inch diameter elements with mesh spacers typically have 5 membrane leaves. The outside diameter of the center tube of a typical 4″ diameter element is 0.84 inches with a circumference of 2.64 inches (67 mm). Spacing between permeate carrier leaves around the center tube is 0.528 inches (13.41 mm). For printed spacer elements, 7 leaves can be wrapped around the center tube for equivalent length membrane sheets. This results in permeate carrier spacing that is 0.377 inches (9.58 mm) sheet to sheet at the center tube.

For economy and ease of fabrication, 1.8-inch (45.7 mm) diameter by 12 inch (304.8 mm) long household elements using mesh spacers typically have just have one leaf. Since the element is only 12 inches long, the mesh thickness can be much thinner that for a 40-inch long element since the differential pressure loss feed to reject is a much shorter distance. In any event, however, printed spacer feed space heights can be half the height of mesh spacers, and two or more leaves can be used versus one leaf in a mesh element. The typical diameter of a 12-inch element center tube is 0.67 inches (17 mm), or a circumference of 2.1 inches (53.46 mm). Sometimes, shorter leaves are used on mesh elements and then two leaves are wrapped around the center tube. Rarely are three leaves used. With two leaves and a 0.67-inch diameter center tube, the permeate carrier spacing is 1.05 inches. Printed spacer elements can have more leaves for the same pressure drop feed to reject, so spacing of permeate carriers to the center tube can be less than 1.05 inches. Three-inch diameter by 12-inch long elements are also getting popular since they can have much greater permeate flow and possibly eliminate the need for a pressure tank in a household system. In any event, the permeate spacing X on the center tube is up half of the distance as mesh spacer elements for an equivalent printed spacer element.

In order to prevent membrane sheet from being forced away from attachment point 23, it is preferred to have a narrow overall width. In particular it is preferred that the distance V from the fold to the first printed features, is greater than the permeate carrier spacing X. This has the effect of holding the leaf in place during rolling, preventing leaks from forming at the insertion point. As the distance from the fold to the first printed feature has an altered mixing characteristic due to the lower channel height, it is desirable that this distance is less than 4″, and more preferably less than 3″, and more preferably less than 2″ and even more preferably less than 1″.

In summary, for 40-inch long elements, forty percent more membrane leaves can be used, meaning spacing can be approximately 30% less (5 leaves vs 7 leaves=0.71), than mesh type elements, and twice as many leaves in 12 inch long elements, or spacing that is 50% less (1 leaf vs 2 leaves=0.5). Of course, there are many combinations of spacer widths, number of leaves, length of elements, and allowable pressure drops feed to reject. In every case, however, the spacing height for printed spacers can be shorter, and the number of leaves greater versus mesh type elements for the equivalent pressure loss feed to reject.

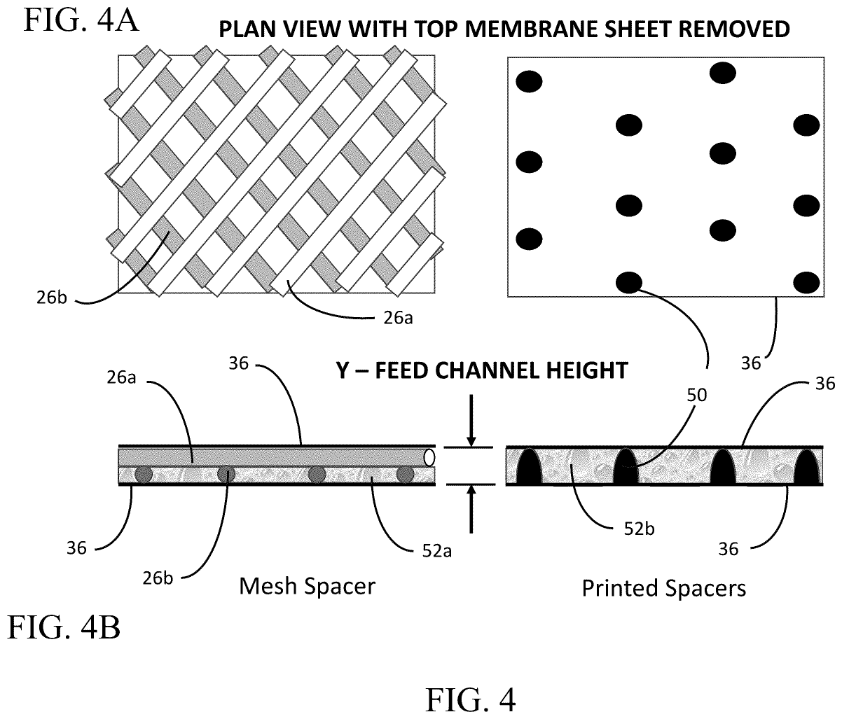

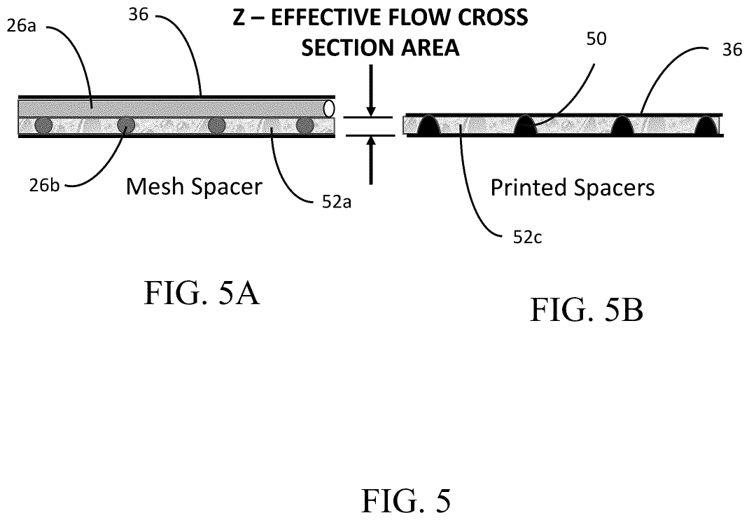

FIGS. 4A and 4B identify one of the key advantages of printed spacer technology. FIG. 4A represents a view of the feed channel of width Y with a mesh spacer 26 in the feed space. Mesh spacer 26 comprises stringers 26a and 26b aligned perpendicular to each other. In practice, stringers 26a and 26b may be at non normal angles less than 90 degrees to each other. Also, mesh spacer 26 will have the stringers oriented at 45 degrees to the flow path. FIG. 4A however, shows the effective blockage of strings 26a allowing flow 52a to be obstructed for half of the flow path width—the feed channel width Y. Printed spacers 50 allow fluid 52b to flow in the full height of feed channel height Y. Clearly, this is a much bigger cross sectional area flow path offering less resistance to flow and lower pressure drop from the feed to the reject end of element 100 (FIG. 1). FIGS. 5A and 5B represent the true effective flow 52a in a mesh spacer with flow 52c in a reduced height printed feed spacer element. The flow cross section areas in both elements are practically the same. Testing has been conducted using industry standard 40 inch long by 4-inch diameter membrane elements—i.e. 4040 elements with conventional 28 mil feed spacer mesh. In comparison, flow tests were also conducted on 13-mil printed spacer elements to determine the pressure drop from the feed to reject end of the elements. Performance data for flux and rejection were not collected in these tests. The purpose of the tests was to demonstrate the significant advantage of printed spacers for lower differential pressure. Flow rates were tested from 4 gallons per minute (GPM) in increments of 2 GPM to 18 GPM, and the differential pressure from the feed to the reject end of the elements were measured. Even though the printed spacer feed channel height (13-mil) was less than half the mesh spacer element height (28-mil), the differential pressure from the feed to the reject end of the element was lower in the printed spacer element.

TABLE 1

| | Differential Pressure, psi | |
|---|---|---|
| Feed flow | 28 mil Mesh | 13 mil Print |
| (GPM) | avg of 3 | avg of 3 |
| 4 | 2.2 | 1.5 |
| 6 | 3.6 | 2.9 |
| 8 | 5.4 | 4.5 |
| 10 | 7.4 | 6.3 |
| 12 | 9.8 | 7.5 |
| 14 | 12.4 | 9.1 |
| 16 | 14.5 | 10.5 |
| 18 | 18.2 | 11.6 |

Furthermore, the differential pressure as a function of feed flow is best described as a power law where

Differential pressure=a*feedflow\hat{ }b

Where b is approximately 1.4 for the mesh element and 1 for the printed element. This provides significantly lower energy losses with savings increasing as feed flow rates increase. Spiral wound elements of this invention preferably have exponent b less than 1.35, more preferably less than 1.2, even more preferably less than 1.1, and even more preferably about 1.

Using a 13-mil printed spacer height, 40 percent more membrane area can be built into a 40″ long element. A 28-mil mesh spacer element 4″ in diameter comprises 5 leaves wrapped around the center tube to achieve a final outside diameter of just less than 4 inches. In the 13-mil height printed spacer element, 7 leaves of the same length can be wrapped around the center tube and still maintain a diameter of just less than 4 inches. The additional membrane material surface area in the printed spacer element provides up to 40 percent more permeate flow under the same operating conditions using the same membrane sheet material in both the mesh element and the printed spacer element. In actual practice, 40 percent more surface area is the upper limit due to the fact that the printed spacer features 50 are printed directly on to membrane sheet 36 and block 3 percent or so of the active surface area. Even so, 37 percent more square footage of active membrane area can be utilized in a 40-inch long printed spacer element versus a mesh spacer element with the same pressure drop feed to reject. This can be described as the areal packing density of the membrane element [active area (in2) per volume (in3) of the element]. Conventional elements using mesh spacers had an areal packing density of up to 31 in2/in3. Example spiral wound elements of this invention are able to achieve areal packing densities of greater than 33 in2/in3, and greater than 35 in2/in3, and even more preferably greater than 39 in2/in3, and greater than 41 in2/in3, and greater than 43 in2/in3.

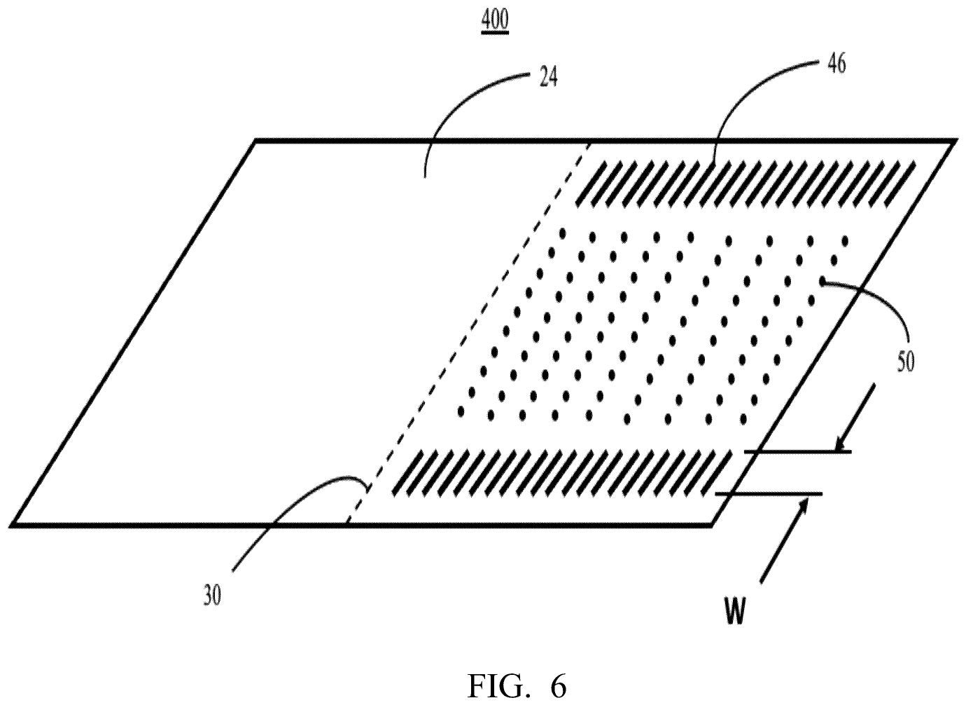

FIG. 6 is a view showing the higher density edge pattern 46 on the inlet and outlet of the printed active membrane surface 24. This higher density edge pattern 46 is preferred in order to support the edges of the membrane element during since the glue line 32 (FIG. 1) pushes against the back side of the membrane sheet 28 (FIG. 1) as the adhesive is forced to flow through permeate carrier 22 (FIG. 1) to make adhesive contact with the opposite inactive surface of membrane sheet 28 (FIG. 1) during rolling. The width W of inlet and outlet edge patterns 46 has a width W that is determined by the adhesive fabrication technique, the viscosity of the adhesive, and other factors. In 40-inch long elements that use manual gluing and rolling techniques, the width W of edge patterns 46 have typically been 3 to 3.5 inches (76 to 89 mm). The length of W needs to be wide enough to provide pressure to the glue line and for element trimming to occur through the patterned area, but this region leads to a larger loss of active area and leads to increased pressure drop from the feed to the reject end of the element, and W should therefore be minimized. Using automated rolling and gluing techniques, the width W of edge patterns 46 at the time of printing (prior to cutting) can be minimized to a width of 2.0 inches (50.4 mm) but more preferably 1.5 inches (38.1 mm).

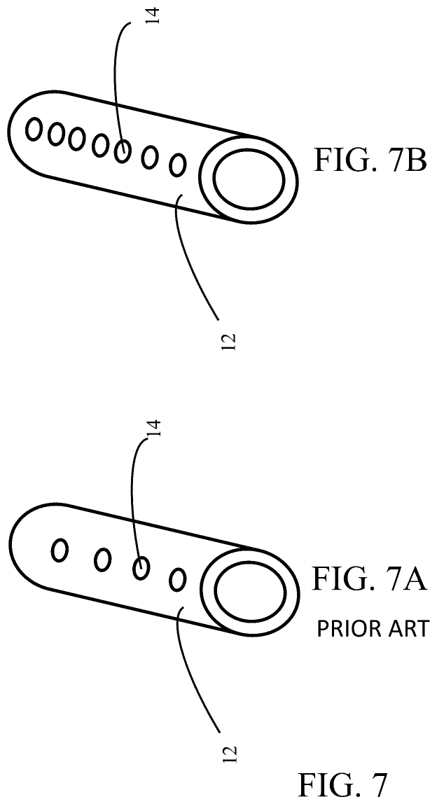

FIGS. 7A and 7B are views of center tube 12 with holes 14 that provide flow of fluid from permeate carriers 22 (FIG. 1). With shorter height printed spacer features 50 (FIG. 3), more membrane envelopes 40 (FIG. 2) can be utilized with any equivalent outside diameter element constructed of conventional mesh spacer 26 (FIG. 1). As more permeate flows to center tube 12, holes 14 must either be larger in diameter or be spaced closer together in order to accommodate the additional permeate flow without increasing the back pressure in permeate carriers 22. With 12-inch long elements, up to twice as many membrane envelopes 40 can be wrapped around the center tube. The spacing density in the case of 12-long elements must therefore be increased two to one in order to avoid backpressure issues in permeate carriers 22. For 40-inch long elements, 40 percent more leaves can be wrapped around center tube 12. In that case, the number of holes 14 must be increased by 40 percent, or the cross-section area of holes 14 must be increased by 40 percent versus the number and/or size (diameter) of holes in conventional mesh fabricated element center tubes. This is particularly important for high flow ultra-filter (UF) and micro filter (MF) spiral wound elements.

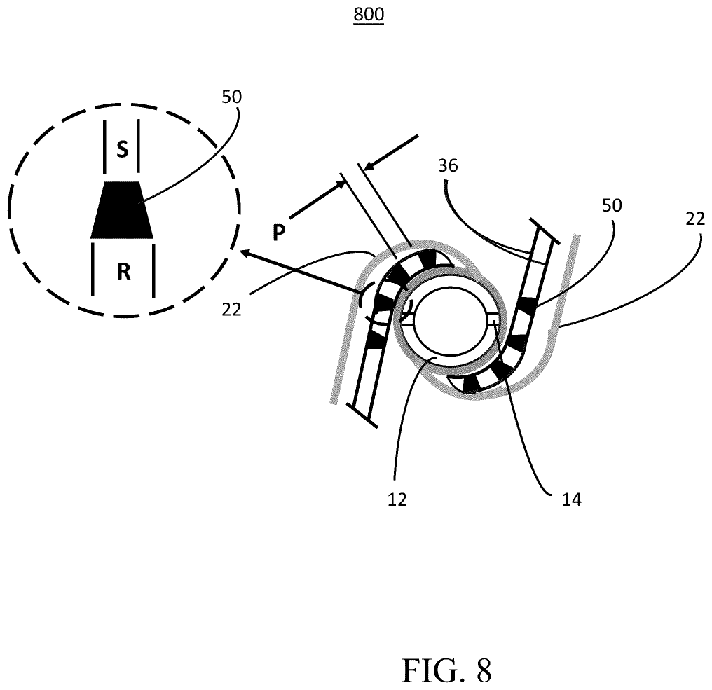

FIG. 8 shows an embodiment of the current invention where the flow path from the feed 16 (FIG. 1) to reject 18 end (FIG. 1) of spiral wound element 100 (FIG. 1) maximizes the flow path due to the shape of spacer features 50. As an example, as printed membrane 36 is wrapped around center tube 12 with spacer features 50 applied to membranes 36, spacer features 50 can be, for example, formed in the shape of a trapezoid, or other shapes having different widths of a feature 50 where S is narrower at the top then the bottom R where it is in contact with the membrane. This is particularly important for edge features 46 (FIG. 6) where the flow path is more narrow and longer as the fluid passes by which contributes to larger differential pressures. As membranes 36 are wrapped around center tube 12 the tops of the trapezoid close together so that the sides of spacer features 50 create parallel walls P providing a more open feed flow path for fluid to enter or exit spiral wound element 100 (FIG. 1). As an alternative to parallel walls after rolling, the side walls of spacer features 50 and edge features 46 (FIG. 6) may not be parallel but may form an arc that is greater than zero degrees so that the feed spacer path is more open than just a path with parallel walls. The net result of a more open flow path is less pressure loss from the feed to the reject end of the element, thereby saving energy in the membrane filtration process. To improve flow channel differential pressure characteristics it has been found that the folded membrane sheet(s) 28 can be oriented in such a manner that for a given feature 50, its location described by width S is closer to the central tube than the side of the feature described by its R in the assembled spiral wound element.

The present invention has been described in connection with various example embodiments. It will be understood that the above description is merely illustrative of the applications of the principles of the present invention, the scope of which is to be determined by the claims viewed in light of the specification. Other variants and modifications of the invention will be apparent to those skilled in the art.

1. A spiral wound element comprising two or more membrane sheets, each membrane sheet being folded on itself at a fold line providing first and second membrane halves facing each other, wherein each folded membrane sheet is spirally wound around the center tube with the fold line proximal the center tube, and the first membrane half forming an inner wind relative to the second membrane half, each membrane sheet having a plurality of spacing features disposed on a surface of at least one of the first and second halves, where the distance from the fold line to the first spacing feature is greater than or equal to the diameter of the center tube divided by the number of membrane sheets with fold lines proximal the center tube.

2. The element of claim 1, wherein the spacing features are disposed on the first membrane half and not on the second membrane half.

3. The element of claim 1, wherein the spacing features are disposed on the second membrane half and not on the first membrane half.

4. The element of claim 1, further comprising a permeable permeate carrier between each pair of adjacent folded membrane sheets.

5. The element of claim 1, wherein the areal packing density of the membrane sheet is greater than 33 in2/in3.

6. The element of claim 5, wherein the areal packing density of the membrane sheet is greater than 35 in2/in3.

7. The element of claim 6, wherein the areal packing density of the membrane sheet is greater than 39 in2/in3.

8. The element of claim 7, wherein the areal packing density of the membrane sheet is greater than 41 in2/in3.

9. The element of claim 8, wherein the areal packing density of the membrane sheet is greater than 43 in2/in3.

10. The element of claim 1, wherein the spacing features have a height extending above the corresponding membrane, where the height of spacing features near the fold line is less than the height of spacing features distant from the fold line.

11. The element of claim 1, wherein the spacing features distant from the fold line by more than the diameter of the center tube have a height that is constant, and spacing features that are closer to the fold line than the diameter of the center tube have a height that increases with distance from the fold line.

12. The element of claim 11, wherein the spacing features distant from the fold line by more than the circumference of the center tube have a height that is constant, and spacing features that are closer to the fold line than the diameter of the center tube have a height that increases with distance from the fold line.

13. The element of claim 11, wherein the spacing features distant from the fold line by more than the diameter of the element have a height that is constant, and spacing features that are closer to the fold line than the diameter of the element have a height that increases with distance from the fold line.

14. The element of claim 1, wherein the spacing features occupy less than 7% of the volume between the membrane halves.

15. The element of claim 14, wherein the spacing features occupy less than 5% of the volume between the membrane halves.

16. The element of claim 14, wherein the spacing features occupy less than 2% of the volume between the membrane halves.

17. The element of claim 1, wherein the spacing features occupy less than 7% of the area of the membrane on which they are deposited.

18. The element of claim 17, wherein the spacing features occupy less than 5% of the area of the membrane on which they are deposited.

19. The element of claim 18, wherein the spacing features occupy less than 2% of the area of the membrane on which they are deposited.

20. An assembly, comprising:
(a) a plurality of folded membranes, each folded membrane comprising a membrane sheet having an active surface and an inactive surface opposite the active surface, the membrane sheet folded in half along a fold line with the active surfaces facing each other, wherein the membrane sheet has disposed thereon a plurality of spacing features with a region less than 0.1 inch from the fold line having no spacing features;
(b) a plurality of permeable permeate carrier sheets;
(c) a center tube;
(d) wherein the permeate carrier sheets are spirally wound about the center tube and welded together with a folded membrane in between each pair of permeate carrier sheets.

21. The assembly of claim 20, wherein the permeate carrier sheets are welded together with a leading edge of each successive permeate carrier sheet separated from the leading edge of the preceding permeate carrier sheet by no more than the circumference of the center tube divided by the number of permeate carrier sheets.

22. The assembly of claim 20, wherein a second permeate carrier sheet is welded to a first permeate carrier sheet at a distance at least the circumference of the center tube and a third permeate carrier sheet is welded to the second permeate carrier sheets at a distance by no more than the circumference of the center tube divided by the number of permeate carrier sheets.
